(19) United States
(12) Patent Application Publication
(10) Pub. No.: US 2007/0193932 A1
(43) Pub. Date: Aug. 23, 2007

(54) WATER PURIFICATION SYSTEM AND METHOD

(76) Inventor: William Nightingale, Mt. Vernon, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/681,909

(22) Filed: Mar. 5, 2007

Related U.S. Application Data
(63) Continuation of application No. 11/184,188, filed on Jul. 18, 2005, now Pat. No. 7,204,930.

(51) Int. Cl. C02F 1/72

(52) U.S. Cl. 210/198.1; 210/758

(57) ABSTRACT

A potable water supply system. The system has an oxidation filtration system to remove dissolved solvents from a water source. The water source provides water with soluble iron and soluble manganese. The water source produces at least about 25,000 gallons per day. The oxidation filtration system is configured to process the water from the water source. The system removes the soluble iron and soluble manganese from the water. The system provides water to at least about 250 people per day. The oxidation filtration system also has a controller configured to vary rates of areating, filtering, discharge, backflushing, and clarification.

### RELATED APPLICATIONS

This application claims priority benefit of U.S. Ser. No. 60/588,677, filed Jul. 16, 2004 and U.S. Ser. No. 11/184,188, filed Jul. 18, 2005.

### BACKGROUND

U.S. Pat. No. 6,187,178 (Lecornu et al.) shows a filter with several back flow means including a siphon. There is an air bleed included which insures the siphon being broken at the proper point.

U.S. Pat. No. 6,063,269 (Miller et al.) shows a filter in a hydraulic system in which a portion of the fluid in the return line, is drawn by Venturi, to the filter line.

U.S. Pat. No. 5,705,054 (Hyrsky) provides a filtered water in-take in which water flows out through pipe. If intake is blocked, flow through siphon tubs brings water in through intake. There is a tube which can be used for siphon control.

U.S. Pat. No. 4,537,687 (Piper) discusses a filter which is cleaned by back flushing. This device shows a reverse siphon started by the application of a section port to initiate a backflow siphon flow in tube.

U.S. Pat. No. 4,317,733 (Xhomnneux) shows a filter with a body and a backflow washing means including a siphon tube. The siphon tube causes the flow of fluid to go backwards. The siphon starts when filter is clogged and the fluid in the chamber reaches a particular level.

U.S. Pat. No. 4,229,292 (Mori et al) discloses a regenerating column which is provided with a flushing siphon that starts when the flushing fluid reaches the desired level. The regeneration operation is started by an operator rather than being an automatic means.

U.S. Pat. No. 3,841,485 (Malkin) shows in a siphon system which has back pressure increases a siphon is developed through a pipe which draws fluid through pipes to draw water through the filter element. There is a siphon breaker tube provided to stop the back flow.

U.S. Pat. No. 3,825,120 (Takahashi) shows a system which includes pump means for moving the fluid being handled. In addition to the pumps there is a siphon pipe means which passes fluid to container.

U.S. Pat. No. 3,549,012 (Mackrle) shows a system in which under cleaning conditions a siphon starts when fluid in it reaches the proper level and air control valves are closed. The suction developed by the siphon is applied to a second siphon to clear an upper section.

U.S. Pat. No. 3,502,212 (Ueda) provides a siphon tube which is filled by liquid as the filter clogs. There are also air flow and feeding means that controls the start and end of the cleaning cycle. When the cleaning cycle is started a siphon liquid flowing draws both liquid and filtered material to a drain.

U.S. Pat. No. 3,342,334 (Soriente et al.) show a filter system in which during the cleaning operation a valve is opened and flushing fluid flows down a pipe. U.S. Pat. No. 3,111,486 (Soriente) shows a back flow system in which liquid is delivered by a tube. When the filter is blocked fluid accumulates so that it reaches a point high enough to flow into a siphon and passes out of the filter system drawing the blocking material with it.

U.S. Pat. No. 2,879,891 (Beohner et al.) shows a filter which is provided with a siphon tube that fills when the back pressure caused by filter blockage, and the position of the air control means allow it to fill. When the siphon tube fills it draws fluid backwards through tubes and backwards through the filter materials and removes it.

U.S. Pat. No. 1,119,008 (Gibson) shows a water filtering system in which there is a pipe loop “L”, that appear to serve as a back flow cleaning siphon when valves are set for back washing. The control is in part a function of automatic float or flow control valves.

U.S. Pat. No. 630,988 (Reisert) shows a back flow system in which as the pressure increases liquid flows up pipe “I”, and down inner pipe “s”, so that a siphon is established.

Ukranian UA 411 (Dmitriyevich) discloses an oxidation/filtration apparatus where as the filtering medium muds the filter loss increases. The water level providing positive flow reaches a maximum height and primes a siphon to initiate rinsing of the filter medium.

### BRIEF DESCRIPTION OF THE DRAWINGS

FIG. 1 is an elevation view of a prior embodiment;

FIG. 2 is an elevation view of the oxidation, filtration, back flush, system;

FIG. 2a is an alternative embodiment elevational view of the oxidation, filtration, back flush, system;

FIG. 3 is an elevation view of the back flushing system;

FIG. 3a is an alternative embodiment elevational view of the back flushing system;

FIG. 4 is an elevation view of the cleansing system;

FIG. 4a is an alternative embodiment elevational view of the cleansing system;

FIG. 5 is a diagram of the programmable logic controller and system elements;

FIG. 6 is a diagram of the control application and control objects;

FIG. 7 is a plan view of the oxidation filtration tank assembly.

### DETAILED DESCRIPTION OF THE EMBODIMENTS

A detailed description of will now be discussed.

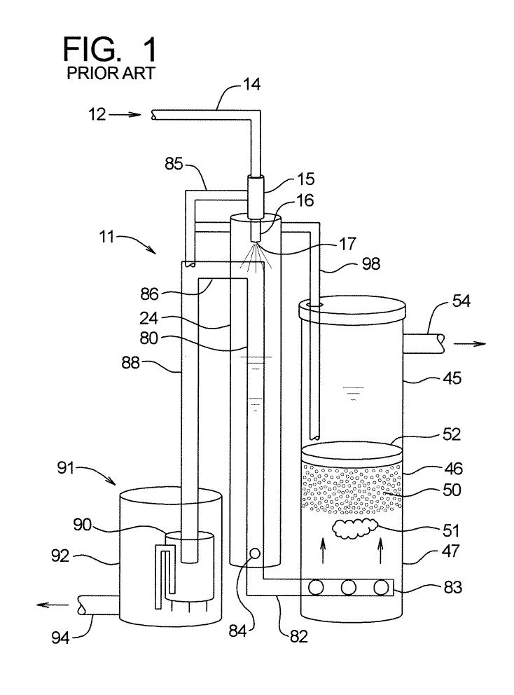

Generally, to remove soluble iron from water an oxidation/filtration process 11 is utilized as shown in FIG. 1. Filtering systems of this sort are generally comprised of two separate categories, the actual filtration process and the back-washing operation to clean the filter.

Still referring to FIG. 1, a common oxidation/filtration system 11 is shown with a filter chamber 46 and a water tower 24. The groundwater 12 is pumped from a groundwater well and fed into a pressurized source line 14. To provide the oxygen, a Venturi-type aerator injector 15 forces compressed air into the groundwater 12, thus creating the first stage of the aeration process. Next, the pressurized water passes through a spray nozzle 16 which disperses the groundwater 12 into a closed water tower 24 completing the aeration process. The water tower 24 is typically cylindrical and stands approximately 20 ft. in height. The aerated water descends to the bottom of the water tower 24, and then it enters into an opening 84 of a cylindrical feed line 80 which is concentric within the water tower 24. The water entering into the opening 84 will flow through a distribution line 82 which directs the water into a manifold 83, the water passes upwardly through the filter chamber 46 in which is positioned a low density filter media 50. At the same time the water is flowing upward through the filter media 50 thus filling the filter chamber 46, the water is also rising in the cylindrical feed line 80.

As the water continues to flow into the filter tank 46, it enters into the upper portion 45 of the filter tank 46 and begins to flow out of the clean water outlet 54. There is a screen 52 at about the mid height of the tank 46 which stops the filter media 50 from migrating from the filter tank lower portion 47 into the filter tank upper portion 45.

When efficient filtration occurs, the water head in the water tower 24 will stay at approximately constant height, which also results in a constant output of clean water running through the clean water outlet 54 of the filter chamber 46. Thus, as the filtration process 11 continues, particulate filtrate matter 51 will begin to accumulate as it attaches in, around and to the low density filter media 50.

Eventually the filter media 50 will become so congested with the particulate 51 that the backwash operation will engage.

This engagement occurs because as more and more particulate 51 attaches to the filter media 50, the filtration flow decreases and water pressure head in the water tower 24 begins to increase. With the building water pressure in the water tower 24 the height of the water in the cylindrical feed line 80 rises.

The water in the cylindrical feed line 80 will reach the level of the connecting line 86 at the top of the feed line 80 which in turn leads to the discharge line 88. The discharge line 88 extends downwardly into a waste lock basin 90 in a holding tank 92. The flow of the water downward in the discharge line 88 creates the siphon vacuum. This vacuum starts drawing water out of the filter tank 46. As the water drops down in the filter tank 46, exiting the holding tank 92, the level of the water in the filter tank 46 will reach the lower end 96 of the vacuum line 98, or in other words, the upper part 45 of the filter tank 46. With this drop in water level, the vacuum line 98 becomes open to atmospheric pressure, and thus interrupts the siphoning action which is occurring in the discharge line 88. The water remaining in the discharge line 88 drops into the waste lock basin 90 and the water remaining in the cylindrical feed line 80 drops back to the distribution line 82 to restart the filtration process.

As previously stated before, the oxidation filtration system 11 will need to perform the siphoning and back flush process on a regular basis. Over time the ferrous soluble iron content in the groundwater will adhere to the inner regions of the cylindrical feed line 80, the distribution line 82, and tend to clog the feed line opening 84, as well as the discharge openings in the manifold 83. Where the soluble iron content is high, the clogging of these various filtration system components will occur more frequently.

This accumulation requires constant maintenance of the oxidation filtration system 11 and over the long term is more expensive to maintain than the preferred embodiment as discussed below.

Even if operation continues unimpeded, the inner diameter of the cylindrical feed line 80 will tend to decrease in size due to the increase in filtrate particulate 51 accumulation. With a smaller diameter comes a slower flow rate through the distribution line 82 and the cylindrical feed line 80 during the discharge process. Additionally, the many bends and turns in the pipes which comprise the discharge system and siphoning process add a level of complexity to the overall design which is not needed.

Additionally the backwash system itself likely will not carry the heavier filtrate particles 51 which are residing in the bottom of the filter chamber 46 up and over the connecting line 86. This tends to leave filtrate particulate 51 accumulations in the elbow between the cylindrical feed line 80 and the distribution line 82. Lastly, immediately after the back flushing process has occurred the groundwater 12 which begins to accumulates and flow upwards starting at the filter tank lower portion 47 and flowing upwards through the low density filter media 50 finally passing through the screen 52, will be cloudy due to the violence turbulence associated with the back flushing process. This cloud will tend to dissipate over time but in many cases the finer particles will be discharged out of the cleaning water outlet 54 and fed into the potable water lines feeding the residences or dairy buildings. To allow the fine filtrate particulate 51 to settle out, a cleansing or clarification period should be provided.

Within this context, an embodiment of the present concept will now be discussed.

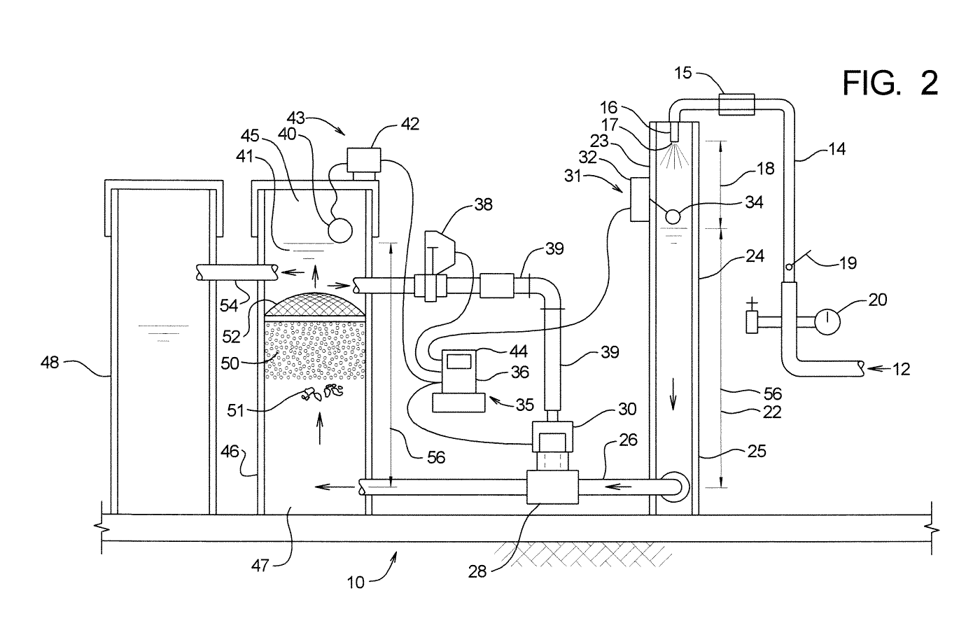

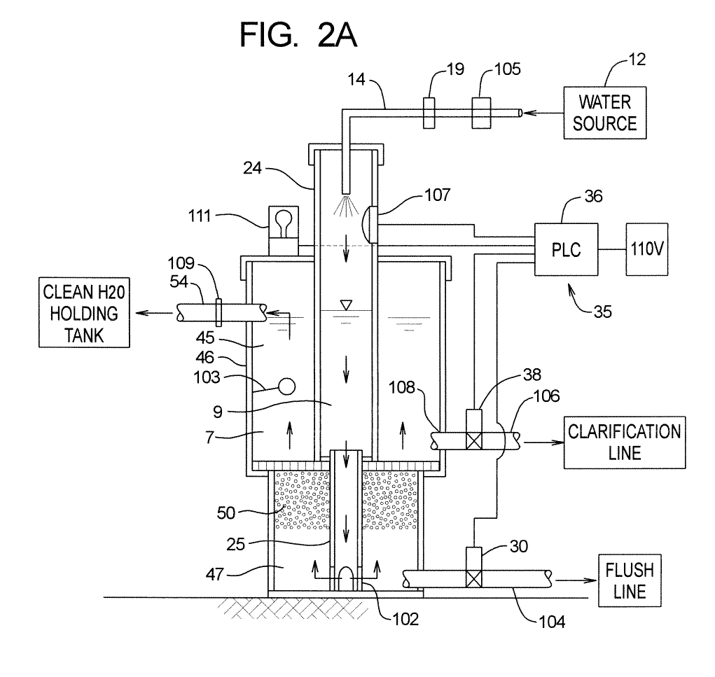

A detailed discussion of a single oxidation filtration system will first be discussed followed by detailed discussion of an assembly of oxidation filtration systems as provided in current embodiment. First referring to FIGS. 2 and 2a, the oxidation filtration system 10 is composed of three main elements: an aeration section 24 also referred to as an aeration tower or water tower 24, a filtration section 46 also referred to as a filtration tank 46, and an oxidation filtration monitoring and cleaning system or flushing system 35. Each of the main components has a series of subcomponents which will be briefly discussed. The aeration tower 24 in the present embodiment is constructed of a 1 foot diameter polyvinyl chloride cylindrical pipe which stands approximately 20 feet in height. The aeration tower 24 has an upper zone 23 and a lower zone 25. The upper zone is configured such that it can accept the outlet 17 of a pressurized groundwater source line 21. Additionally, the lower zone 25 has a close-bottomed portion to keep the groundwater 12 contained. Feeding into the aeration section 23 also referred to as the aeration tower upper zone 23 as previously discussed, is the groundwater source line 21 which holds pressurized groundwater 12 accumulated from the on-site water sources.

The groundwater must be pressured prior to being sprayed into the aeration tower upper zone 23. Pressure is provided from a pressure source, and a pressure meter 20 is attached to the source line 14 so that monitoring of the groundwater pressure can occur. A source line valve handle 19 enables the operator to turn the filtration system 10 on and off as desired. The pressurized water runs through a Venturi-type aerator injector 15 which is attached to the source line 14 near the source line outlet 17. Connected to the end of the source line, is a spray nozzle 16. After running through the Venturi-type aerator 15, the groundwater exits through the spray nozzle 16 which further acts to aerate the groundwater 12 thus converting the soluble ferrous iron content into a nonsoluble form, completing the oxidation portion of the process and allowing the particulate ferrous content 51 as described further herein to drop out of the groundwater 12.

Once the groundwater has been aerated, the ferrous content is ready to drop out of the groundwater upon contact with a medium which has an attracting valence charge. Referring to FIG. 2, connected to the aeration section lower chamber 25 also referred to as the aeration tower lower zone 25 is a source water crossover pipe 26. This crossover pipe feeds the groundwater 12 from the aeration tower into the filtration tank 46. Referring to FIG. 2a, in an alternative embodiment, the aeration tower 24 is positioned within the filtration tank 46. This combination eliminates the need for the crossover pipe 26 as seen in FIG. 2. In this alternative embodiment, the aerated water 9 exits directly out of the aeration tower lower zone 25 and into the filter tank lower zone 47 through an exit port 102.

Referring back to FIG. 2, the filter tank 46 is in the current embodiment constructed of a 3 foot diameter cylindrical polyvinyl chloride housing or pipe and has a filtration section lower chamber 47 also referred to as a filter tank lower zone or lower chamber 47 and a filtration section upper chamber 45 also referred to as a filter tank upper zone or upper chamber 45. In the current embodiment, the filter tank 46 stands approximately 6 feet in height. Approximately mid-height of filter tank 46 is a secured media mesh filter 52, which is essentially a size 10 filter mesh. Contained within the lower chamber 47 is a plurality of low density buoyant filter media 50. In the current embodiment, this filter media is composed of a plurality of very small Styrofoam™ spheres. Each sphere measures approximately 1/100 of an inch in diameter. To provide for effective filtration, in the current embodiment, the volume of the filter media 50 is approximately 30 inches deep and 3 feet in diameter, which corresponds to the inner diameter of the filter tank 46. To contain the water, the filter tank lower chamber 47 has a closed bottom portion which is watertight.

A brief discussion of the pipes or ports associated with the flushing system will now be provided. Part of the overall monitoring and cleaning or flushing system 35 is the opening and closing of various ports or exit and entrance pipes to create the desired turbulence in the filtration tank lower chamber 47 as well as to clarify the dislodged ferrous particulate after the turbulent back flushing.

Referring to FIG. 2, the current embodiment is provided with a plurality of pipes which include the source water crossover pipe 26, the clarifying or cleansing pipe 39, and the back flush pipe 28. Attached to the pipes are a series of control valves or ports. As previously discussed, the crossover pipe 26 is positioned substantially at the bottom of the lower chamber 47 near the floor of the filtration tank 46. Approximately midway between the filtration tank and the aeration tank the back flush pipe intersects the source water crossover pipe at a junction point. At this junction, the back flush pipe 28 is connected to a discharge port 30 also referred to as a back flush valve 30. The back flush valve 30 is a standard automated valve having a weir and a control box which operates the weir.

A clarifying pipe 39 is provided at the filter tank upper chamber to allow cloudy or turbulent water to be drained. The cleansing or clarifying pipe 39 leads from the filter tank upper chamber 45 and connects to the vertically lower back flush pipe 28 at a second junction. The clarifying pipe 39 also has a filtration section clarification port (FSCP) 38 also referred to as a clarifying valve 38, with the same standard automated valve having a weir and control box as the back flush valve.

Referring now to FIG. 2a, the alternative embodiment for the monitoring and cleaning system 35 includes the use of a back flush line 104 and a clarification line 106. In this embodiment, the back flush line and the source water exit port 102 are separated to provide for a simpler operating system. The back flush line 104 is positioned at or near the bottom of the filtration tank 46 in the filtration tank lower chamber 47. Connected to the back flush line 104 is a filtration section discharge port (FSDP) 30 also referred to as a back flush valve 30 having a control box and weir, the control box being electronically operable by the programmable logic controller 36. During normal operation, the back flush valve 30 is in its closed position keeping water within the filter tank 46.

Providing a means of clarifying cloudy groundwater is a clarification line 106 located within the upper chamber 45 of the filter tank. This clarification line also has the clarification valve 38 which operates the same as the back flush valve 30. After the turbulence in back flushing has occurred, a clarifying period is run which allows the finer particulate to settle out.

During normal operational flow the aerated water 9 will generally accumulate in the aeration tower 24 building up a pressure head 22 which drives the corresponding discharge rate out of the filtration tank 46. The discharge rate stays relatively constant based on a discharge pressure which correlates to the pressure head 22 in the aeration tower 24. The filter media 50 has a certain porosity between the actual media particles which will allow for only a maximum flow rate through the filter media 50. The pressure head 22 in the aeration tower 24 will build until the flow rate through this filter media equals the pressure head from the aeration tower. As the filtered water 7 enters into the upper chamber 45 of the filter tank, it accumulates until the top layer of the water reaches the filtered water exit pipe 54. This exit pipe 54 has enough cross-sectional area to maintain a constant volume of filtered water 7 within the filter tank 45 upper chamber.

As a natural consequence of filtering the iron or particulate out of the groundwater, the lower chamber 47 of the filter tank in the filter media 50 will accumulate the filtered particulate until such time as the filtering is ineffective. Also, the particulate will tend to reduce the flow rate through the filter media and the corresponding pressure head 22 will need to increase, thus building the height level of the aerated water within the aeration tower 24.

Many geographic regions have significant amounts of soluble iron or manganese within the groundwater and therefore flushing of the lower chamber 47 of the filter tank can be beneficial for the life expectancy of the oxidation filtration system. There are many ways to monitor and trigger the back flushing of the filtration tank 46. Speaking broadly, these include monitoring of the pressure head 22 as it increases in the aeration tank 24, monitoring the filtered water quality 7 in the upper chamber 46 of the filter tank, monitoring the amounts of soluble compounds in the local groundwater supply to determine an optimal periodic back flushing setting.

To coordinate the sequence of monitoring and cleaning of the oxidation filtration system, an oxidation filtration monitoring and cleaning system 35 is provided that will now be discussed. Referring to FIGS. 2 and 2a, the system utilizes a programmable logic controller in combination with a series of sensors and valves. The sensors monitor the water levels within the aeration tank 24 and the filtration tank 46, and the valves or ports control the opening and closing of the back flush line 104 and the clarification line 106 as well as the water source line 14. The programmable logic controller coordinates the sequencing of opening and closing various valves or ports as well as monitoring the water levels to stay within operational parameters.

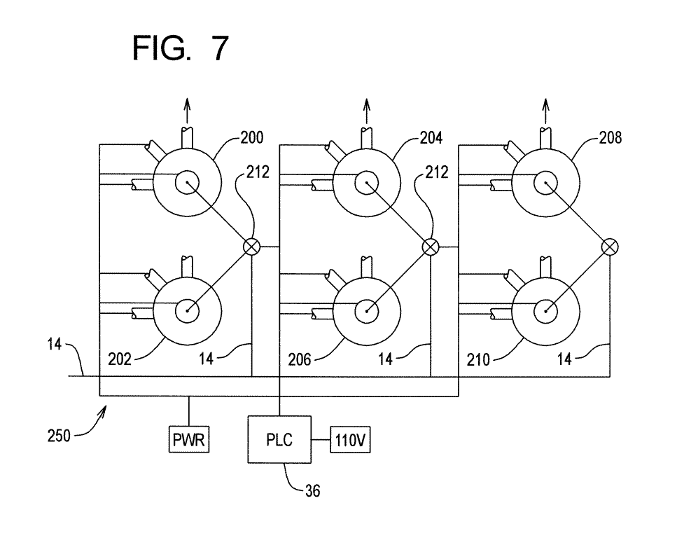

During the course of filtration, an emergency such as a high-level water sensor may be engaged, the sensor then immediately sends from the PLC a signal to set off the alarm 111 and alert the owners of the system that there is a high water level within the aeration tower 24. The PLC can also operate the solenoid of an oxidation filtration system control valve or port 212 which is designed to alternate the use of an off-line and online oxidation filtration system connected in series. This will be further discussed as seen in FIG. 7 below.

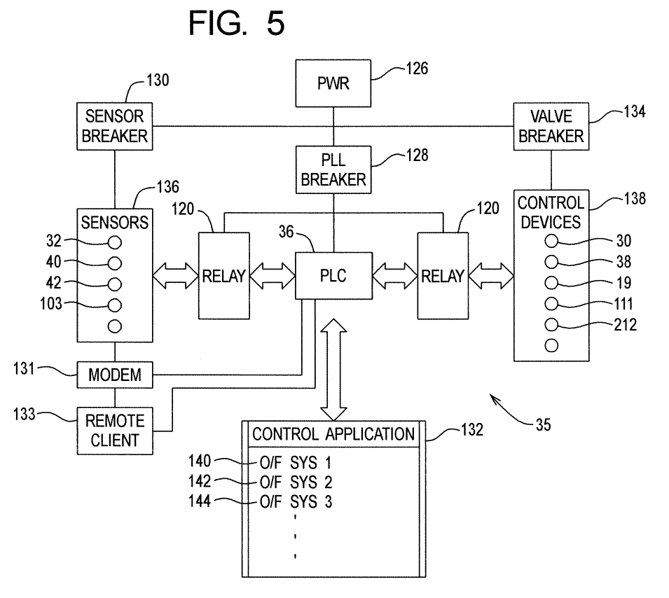

Referring to FIG. 5 for remote operation, the PLC 36 is connected to a communications component or device 131 such as a modem. The modem 131 allows a remote client 133 to connect to the operating system of the PLC 36 and operate the control application 132.

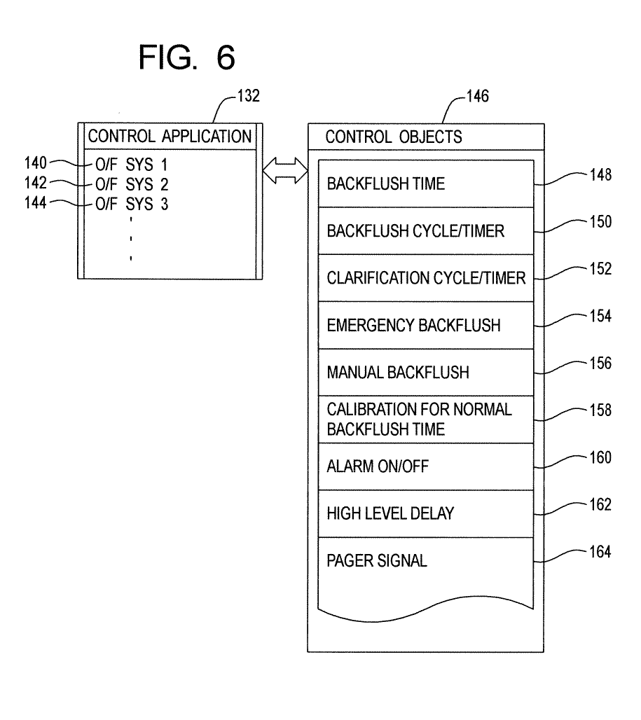

The control application 132 is configured to allow for varying control and sensor settings for the various oxidation filtration systems 10. The control application 132 is configured to operate the controller components including the valves or ports and sensors of the various oxidation filtration systems such as oxidation filtration system applications 1 through 3, FIG. 6.

Because each oxidation filtration system 10 has essentially the same type of sensors 136 and control devices 138, the control application implements a sub-application such as an available oxidation filtration system application 1 140. The sub-application will then draw from a series of control objects 146 as seen in FIG. 6, to implement an instance of the particular control application 132 of the specific system 140.

Of course other programming paradigms may be used such as a non-object-oriented programming language including Basic, Fortran, or an assembly programming language specifically designed for the programmable logic controller.

Still discussing FIG. 6, the functions or objects which run for each system include a back flush time 148, where the back flush time indicates the time of day the oxidation filtration system 10 will initiate a system flush. Referring back to FIG. 2a, the programmable logic controller 36 will send a signal to the back flush port or valve 30 to open the valve and discharge the water in the filtration tank 46 and aeration tower 24. The water in both tanks or sections will provide enough pressure head to turbulently force the water out through the back flush line 104. This turbulence within the lower chamber 47 of the filter section or tank 46 will wash the filtration media 50 of most of the accumulated particulate.

The users can also set a period of time for the back flushing to take place. This is considered the back flush cycle 150. The back flush cycle tells the programmable logic controller 36 how long the back flush valve 30 is to stay open. Similarly, and referring back to FIG. 6, after the back flush has occurred the control application 132 will indicate to the programmable logic controller 36 the amount of time that the clarification port or clarification valve 38 is to remain open so that the system can clarify the water previously back flushed. The clarification period or clarification cycle or timer 152 can be set by the user usually to approximately 20 minutes.

The control objects class 146 also contains a setting for emergency back flush 154. This occurs when one of the high-level sensors within the aeration tower 24 such as the diaphragm sensor 107 as seen in FIG. 2a, signals to the PLC 36 that the pressure head 22 within the aeration tower 24 has increased beyond acceptable limits and the system must be back flushed. Thus the emergency back flush object 154 will signal the programmable logic controller to operate the back flush valve 30 and begin the flushing cycle. Also, a manual back flush object 156 is provided so that the users can either through the remote client 133 or at the display screen of the programmable logic controller 36 operate a manual back flush of the entire filtration system 10.

An additional control object within the control application 132 is a calibration for normal back flush time 158. This calibration for normal back flush time calculates the mean or the average time between the system back flushes, and provides an optimization or recommended setting for the back flush time object 148. This calibration for normal back flush time 158 is beneficial because as previously discussed; each geographic region which requires the oxidation filtration services has different levels of soluble compounds and thus requires different frequencies for washing or cleaning of the filter media 50 as seen in FIG. 2a.

To keep the filtration system running relatively smoothly, a high-level delay object 162 is provided. During the course of operation, the aeration tower 24 may experience high-level water false-starts or in other words false warnings, which have been triggered from splashing or a short period of reduced filtration flow. The high-level delay object 162 allows the user to set the amount of time that the high water float 34 or the diaphragm sensor 107 must be activated or raised before the emergency back flush object 154 will signal the back flush valve 30 to begin the system flush.

To notify the system operator or the owner of the oxidation filtration device that an unscheduled back flushing event has occurred, a series of alarms have been designed to communicate the emergency status. After a signal has been received from one of the sensors 136 as seen in FIG. 5, the control application 132 as seen in FIG. 6, will activate an alarm object 160. The alarm object will then send a control signal to the physical alarm 101 as seen in FIG. 2a which in the current embodiment is attached to the top cover plate of the filter tank 46. The alarm 111 has a flashing warning light as well as a sound/audible warning.

The alarm object 160 has an alarm delay which delays the audible alarm initiation. This delay allows response from the pager alarm discussed below from irritating or annoying residents within the vicinity of the oxidation filtration system. The alarm object 160 will also send a signal through the communications device or modem 131 to a pager service located at a remote client 133 which then notifies the owner of the high-level emergency. The alarm object 160 has an audible silence control which when activated allows the operator to work on the emergency system without the audible alarm causing a distraction. If the high-level emergency is not corrected within a period of time, the audible alarm will then re-activate until such time as the back flush occurs.

In addition to servicing dairy farms and other agricultural operations, the oxidation filtration system 10 can also be used to process groundwater for a small municipality. The current embodiment provides for each filtration unit to process approximately 25,000 gallons to 30,000 gallons per day. An average person will typically use between 75 to 100 gallons of water per day. Therefore, the typical 25,000 gallon processing filtration unit can service approximately 250 people each day. To service between 1,000 people to 2,500 people equating to a small municipality or medium-size subdivision, having between five and ten filtration units running in parallel producing between 125,000 gallons to 250,000 gallons of filtered water each day would be beneficial to the local governmental authority.

The current preferred embodiment for the oxidation filtration tank assembly 250 as seen in FIG. 7 has arranged a three unit filtration output in parallel, with two units for each output line in series. This tank assembly configuration 250 allows the users to perform maintenance on one of the off-line filtration tanks while still producing filtered water through the online tank.

The system can produce approximately 75,000 gallons of water constantly per day. The current embodiment of the programmable logic controller 36 can coordinate five filtration tanks in parallel. The tanks currently producing filtered water and the assembly as shown in FIG. 7 are online tank 1 at 200, online tank 2 at 204, and online tank 3 at 208. The groundwater source line 14 provides the groundwater through an oxidation filtration system control valve 212. The programmable logic controller 36 monitors the operation of the online tanks and if a back flushing sequence occurs or the tank goes off-line, then the PLC will signal the oxidation filtration system control valve 212 to redirect the groundwater from the groundwater source line 14 to the backup system such as backup oxidation filtration system 202 to keep the production output at a constant rate. Also, by having a plurality of filtration tanks in series and parallel, the assembly 250 is in a better position to meet peak load demands and low load demands based on daily population needs.

A brief discussion of the overall process or method as it operates in the current embodiment will now be provided.

Reference will be made to FIGS. 2 through 7 including the alternative embodiments of FIGS. 2A through 4a. Referring first to FIG. 7, the oxidation filtration tank assembly 250 of the current embodiment is arranged in a three parallel output filtration configuration with each parallel output line having 2 filtration tanks in series. The groundwater flows through the groundwater source line 14 and is directed through each of the oxidation filtration system control valves 212 to the online oxidation filtration system tank. Pressure in the source line 14 is provided by the source line pump and the pressure can be read on the pressure meter 20 as seen in FIG. 2. The operator can initiate the filtration process by first turning on the source line valve or port 19 by either utilizing the programmable logic control application 132 through a remote client 133 or by using a manual valve handle. The water is immediately injected into the Venturi-type aerator 15 and after the initial aeration, the groundwater passes through the spray nozzle 16 and falls into the aeration tower upper zone or chamber 23. The groundwater is further aerated by dropping through the aeration tower 24 to the bottom of the tower. The groundwater then after being aerated enters into the lower chamber 47 of the filter tank 46 either through the source water crossover pipe 26 or through the exit port 102 as seen in FIG. 2a. The water level in the filter tank lower chamber 47 and the aeration tower 24 continues to rise at an equal constant rate until the filter tank lower chamber 47 is full. During this initial filling process, the filter tank lower chamber 47 containing the filter media 50 filters the water through the filter media and the filter media is pressed or pressurized against the media mesh 52 dividing the upper chamber from the lower chamber.

At this stage, the source groundwater 12 begins to fully filter through the filter media 50 as the water pressure static head 22 in the aeration tower 24 begins to increase forcing the water through the filter media and beginning the filter rate of the source groundwater through the media until a steady-state flow rate is reached.

The surface area of the individual filter media is such that it readily attracts the iron oxide particles thus taking the particulate out of the groundwater. The aerated water 12 filters through the filter media and enters into the upper chamber 45 of the filtered tank 46. The filtered water contained within the upper chamber 45 will exit through the filtered water crossover pipe 54 or the exit port 54 and dropped into a holding tank 48.

Filtering of the groundwater continues unimpeded for the filtering cycle until such time as the filtration rate through the filter media decreases. As the filter rate slows, the static head pressure 22 in the aerated tower 24 begins to build. At a certain point the static head pressure 22 reaches the high-level float 34 or the diaphragm sensor 107 and then sends a back flush or discharge signal from the back flush sensor 32 or diaphragm sensor 107 to the programmable logic controller 36.

At this point in the process, the programmable logic controller runs the control application 132 for the particular oxidation filtration system 140. Depending on the operational settings held within the various control objects 146 the alarm 111 may be delayed from sounding because the users may have set the high-level delay 162 to for example five minutes. Simultaneously, the control application 132 will send a pager signal 164 through the modem 131 to the remote client 133 which in this case would be the pager of the on-site operator. The pager would then notify the operator of the emergency situation and the operator could take a number of actions. One of the actions would be for the operator to access the control application 132 through the remote client 133 connected to a modem 131.

The operator could then check the system status of the particular oxidation filtration system to determine if the alarm signal is an actual high-level emergency or is just a false alarm.

The operator can then verify that the water pressure level 22 in the aeration tower 24 has reached the high-level float 34 or the diaphragm sensor 107 and a back flush or system flush should be initiated. After the back flush has been initiated, the operator can direct the programmable logic 36 to send a signal to the oxidation filtration system control valve or port 212 as seen in FIG. 7, to switch the groundwater source 14 from the back flushing oxidation filtration system 200 to the backup oxidation filtration system 202.

The calibration for the normal back flush time 158 will then take place recalculating the average amount of time between back flushes and reset the back flush time object 148. This recalibration can occur for each of the oxidation filtration systems within the assembly 250.

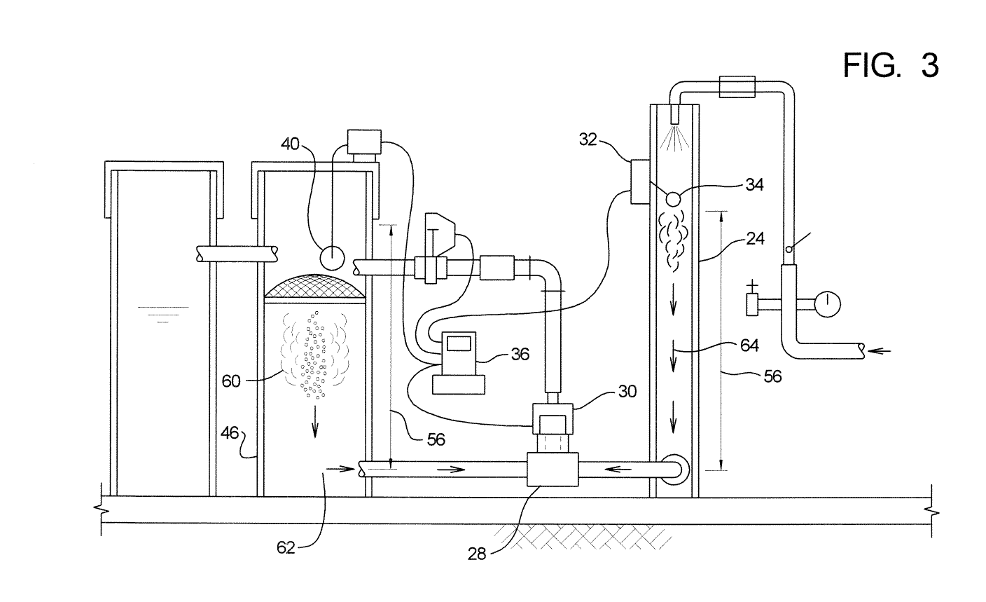

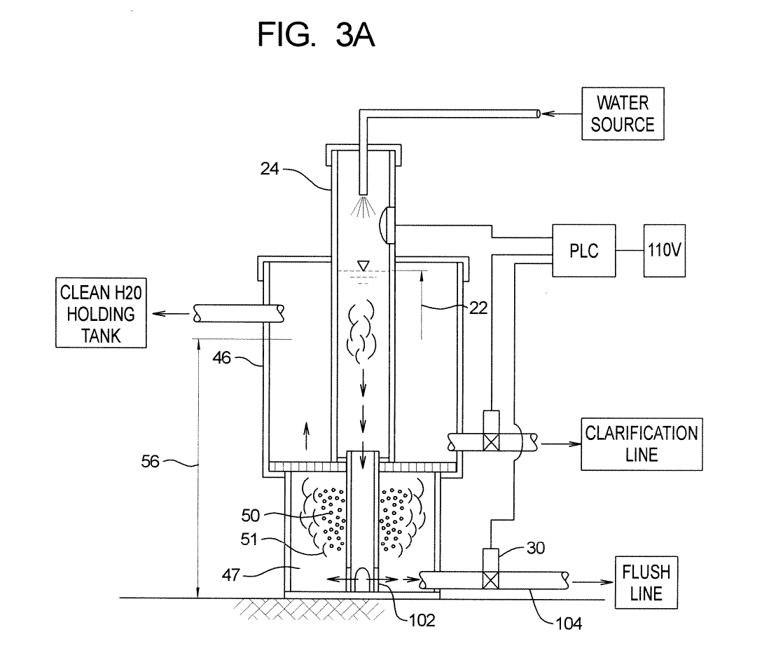

The filtration will continue until the back flush time 148 signaled to the programmable logic controller 36 that a back flush cycle 150 should occur. The programmable logic controller will then signal the back flush valve 30. Referring to FIGS. 3 and 3a, the solenoid of the back flush valve 30 will open the valve and the back flushing process will begin again. The static pressure head 22 within the aeration tower 24 as well as the filtered tank static pressure head 56 create a substantially large flow rate through the back flush line 104 and creating significant turbulence 51 in the lower chamber 47 of the filtered tank 46. This turbulence 51 buffets and washes the filter media 50 as the groundwater contained within the aeration tower 24 in the filtration take 46 quickly exit through the back flush line 104.

This process of back flushing and rinsing the filter media 50 occurs for the entire period of the back flush cycle timer 150 as set in the control application 132.

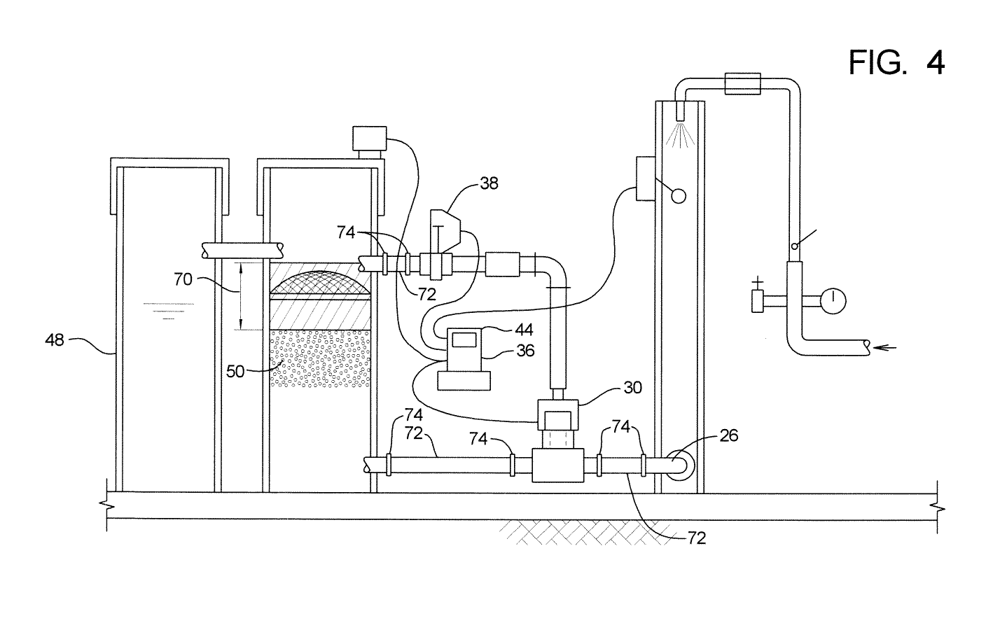

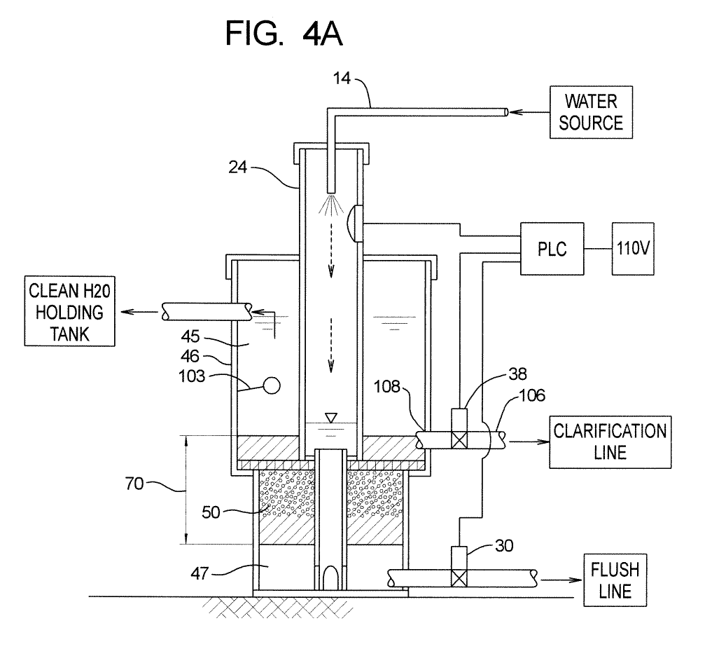

After the time period has elapsed, the programmable logic controller then signals the clarification valve or port 38 as seen in FIGS. 4 and 4a to open and simultaneously closes the back flush valve 30 allowing the water pressure from the source line 14 to accumulate in the aeration swap tower 24 and the filter tank 46. The filter media 50 has been washed of the oxidation deposits and returns to its buoyant state.

Because of the significant turbulence which occurred in the back flushing process, iron or other particulate is suspended within the groundwater and may be residual in the upper chamber 45 and the lower chamber 47 of the filter tank 46. In lieu of waiting for the dislodged particulate to settle out, a clarification process is provided where the clarification line 108 in the upper chamber 45 is opened by the clarification port 38 to clean and dispose of the cloudy groundwater 70.

The control application runs the clarification cycle for the desired period of time as set in the clarification cycle timer object 152. Alternatively, the particulate sensor 103 can monitor the level of particulate within the upper chamber 45 during the back flushing process to then send a signal to the programmable logic controller that the clarification cycle should begin and then terminate when the particulate levels in the upper chamber diminish to an acceptable filtered level.

However the clarification period 152 is determined, the cloudy water 70 exits through the clarification line 106 for the clarification cycle 52 until the cycle is complete. One embodiment has this cycle lasting approximately 30 minutes. After the clarification cycle is complete, the clarification port 38 is closed by the programmable logic controller sending a signal to the solenoid of the clarification valve or port to close the aperture.

Once the entire flushing cycle has taken place, the groundwater within the aeration tower 24 is allowed to build up pressure head 22 until such time as the filtration rate reaches its normal equilibrium state and filtration of the groundwater continues.

After continuous use of the oxidation filtration tanks 10, such as for a year or two, maintenance of the oxidation filtration back flush assembly or tank 10 may be required. The accumulation of the iron particulate or other crud may occur generally within the crossover pipe 26 or block the exit port 102 as seen in FIGS. 2 and 2a. Consequently, either a plurality of cleanout pipes 72 is provided or cleanout ports within the bottom chamber of the filter tank 46 are provided.

Each cleanout pipe section 72 is attached to a manifold 74 with a gasket 76. When the crossover pipe 26 becomes clogged with particulate, the operator can shut down the system and remove the cleanout pipes 72. Similarly, when the exit port 102 becomes clogged and the aeration tower 24 can no longer pass water from the aeration tower into the lower chamber of the filter tank 47, the operator can shut down the entire process, remove the filter tank cover and extract the aeration tower 24 from the interior of the filter tank. The media mesh 52 can be removed and cleanout of the filter tank and of the aeration tower can occur relatively inexpensively. This use of maintenance allows for long life of the oxidation filtration tank 10.

Therefore I claim:

1. A potable water supply system comprising:
a. an oxidation filtration system to remove dissolved solvents from a water source;
b. said water source comprising water, said water comprising soluble iron, soluble manganese; said water source further comprising the production of at least about 25,000 gallons per day;
c. said oxidation filtration system configured to process at least about 25,000 gallons per day of said water; said oxidation filtration system removing said soluble iron and soluble manganese from said water;
d. said oxidation filtration system providing water to at least about 250 people per day;
e. said oxidation filtration system further comprising a controller configured to vary: the rate at which said water is aerated in said oxidation filtration system, the rate at which said water is filtered in said oxidation filtration system, the rate at which said water is discharged from said oxidation filtration system, the rate at which said water is back flushed in said oxidation filtration system, the rate at which said water is clarified in said oxidation filtration system.

2. The potable water supply system according to claim 1 wherein said oxidation filtration system further comprises a first oxidation filtration unit, said first oxidation filtration unit comprising a first aeration section and a first filtration section, said first filtration unit processing said at least about 25,000 gal. per day of said water and enabling said oxidation filtration system to provide water to at least about said 250 people per day; said first oxidation filtration unit operated by said controller.

3. The potable water supply system according to claim 2 wherein said oxidation filtration system further comprises a second oxidation filtration unit, said second oxidation filtration unit comprising a second aeration section and a second filtration section, said second filtration unit processing at least about 25,000 gal. per day of said water enabling said oxidation filtration system to provide water to at least about 500 people per day; said second oxidation filtration unit operated in conjuction with said first oxidation filtration unit by said controller.

4. The potable water supply system according to claim 3 wherein said oxidation filtration system further comprises a third oxidation filtration unit, said third oxidation filtration unit comprising a third aeration section and a third filtration section, said third filtration unit processing at least about 25,000 gal. per day of said water enabling said oxidation filtration system to provide water to at least about 750 people per day; said third oxidation filtration unit operated in conjuction with said first and second oxidation filtration units by said controller.

5. The potable water supply system according to claim 4 wherein said oxidation filtration system further comprises a fourth oxidation filtration unit, said fourth oxidation filtration unit comprising a fourth aeration section and a fourth filtration section, said fourth filtration unit processing at least about 25,000 gal. per day of said water enabling said oxidation filtration system to provide water to at least about 1000 people per day; said fourth oxidation filtration unit operated in conjuction with said first, second, and third oxidation filtration units by said controller.

6. The potable water supply system according to claim 5 wherein said oxidation filtration system further comprises a fifth oxidation filtration unit, said fifth oxidation filtration unit comprising a fifth aeration section and a fifth filtration section, said fifth filtration unit processing at least about 25,000 gal. per day of said water enabling said oxidation filtration system to provide water to at least about 1250 people per day; said fifth oxidation filtration unit operated in conjuction with said first, second, third and fourth oxidation filtration units by said controller.

7. The potable water supply system according to claim 6 wherein said oxidation filtration system further comprises a sixth oxidation filtration unit, said sixth oxidation filtration unit comprising a sixth aeration section and a sixth filtration section, said sixth filtration unit processing at least about 25,000 gal. per day of said water enabling said oxidation filtration system to provide water to at least about 1500 people per day; said sixth oxidation filtration unit operated in conjuction with said first, second, third, fourth and fifth oxidation filtration units by said controller.

8. The potable water supply system according to claim 7 wherein said oxidation filtration system further comprises a seventh oxidation filtration unit, said seventh oxidation filtration unit comprising a seventh aeration section and a seventh filtration section, said seventh filtration unit processing at least about 25,000 gal. per day of said water enabling said oxidation filtration system to provide water to at least about 1750 people per day; said seventh oxidation filtration unit operated in conjuction with said first, second, third, fourth, fifth and sixth oxidation filtration units by said controller.

9. The potable water supply system according to claim 8 wherein said oxidation filtration system further comprises an eighth oxidation filtration unit, said eighth oxidation filtration unit comprising a eighth aeration section and a eighth filtration section, said eighth filtration unit processing at least about 25,000 gal. per day of said water enabling said oxidation filtration system to provide water to at least about 2000 people per day; said eighth oxidation filtration unit operated in conjuction with said first, second, third, fourth, fifth, sixth and seventh oxidation filtration units by said controller.

10. The potable water supply system according to claim 9 wherein said oxidation filtration system further comprises a ninth oxidation filtration unit, said ninth oxidation filtration unit comprising a ninth aeration section and a ninth filtration section, said ninth filtration unit processing at least about 25,000 gal. per day of said water enabling said oxidation filtration system to provide water to at least about 2250 people per day; said ninth oxidation filtration unit operated in conjuction with said first, second, third, fourth, fifth, sixth, seventh and eighth oxidation filtration units by said controller.

11. The potable water supply system according to claim 10 wherein said oxidation filtration system further comprises a tenth oxidation filtration unit, said tenth oxidation filtration unit comprising a tenth aeration section and a tenth filtration section, said tenth filtration unit processing at least about 25,000 gal. per day of said water enabling said oxidation filtration system to provide water to at least about 2500 people per day; said tenth oxidation filtration unit operated in conjuction with said first, second, third, fourth, fifth, sixth, seventh, eighth and ninth oxidation filtration units by said controller.

12. The potable water supply system according to claim 6 wherein said oxidation filtration system further comprises said first through said fifth oxidation filtration units operated in parallel.

13. The potable water supply system according to claim 6 wherein said oxidation filtration system further comprises said first through said fifth oxidation filtration units operated in series.

14. The potable water supply system according to claim 11 wherein said oxidation filtration system further comprises said sixth through said tenth oxidation filtration units operated in parallel.

15. The potable water supply system according to claim 11 wherein said oxidation filtration system further comprises said sixth through said tenth oxidation filtration units operated in series.

16. The potable water supply system according to claim 11 wherein said oxidation filtration system further comprises said first through said tenth oxidation filtration units operated in parallel.

17. The potable water supply system according to claim 11 wherein said oxidation filtration system further comprises said first through said tenth oxidation filtration units operated in series.

18. The potable water supply system according to claim 11 wherein said oxidation filtration system is further comprised to discharge to a municipal water supply.

19. A method for providing potable water, said method comprising:
a. removing dissolved solvents from a water source by using an oxidation filtration system;
b. producing from said water source at least about 25,000 gallons per day, said water source comprising water, said water comprising soluble iron, soluble manganese;
c. processing at least about 25,000 gallons per day of said water through said oxidation filtration system by removing said soluble iron and soluble manganese from said water;
d. providing water from said the oxidation filtration system to at least about 250 people per day;
e. controlling the oxidation filtration system by:
i. varying the rate at which said water is areated in said oxidation filtration system;
ii. varying the rate at which said water is filtered in said oxidation filtration system;
iii. varying the rate at which said water is discharged from said oxidation filtration system;
iv. varying the rate at which said water is back flushed in said oxidation filtration system;
v. varying the rate at which said water is clarified in said oxidation filtration system.

20. A method for providing potable water, said method comprising:
a. means for removing dissolved solvents from a water source by using an oxidation filtration system;
b. means for producing from said water source at least about 25,000 gallons per day, said water source comprising water, said water comprising soluble iron, soluble manganese;
c. means for processing at least about 25,000 gallons per day of said water through said oxidation filtration system by removing said soluble iron and soluble manganese from said water;
d. means for providing water from said the oxidation filtration system to at least about 250 people per day;
e. means for controlling the oxidation filtration system by:
i. providing means to vary the rate at which said water is areated in said oxidation filtration system;
ii. providing means to vary the rate at which said water is filtered in said oxidation filtration system;
iii. providing means to vary the rate at which said water is discharged from said oxidation filtration system;
iv. providing means to vary the rate at which said water is back flushed in said oxidation filtration system;
v. providing means to vary the rate at which said water is clarified in said oxidation filtration system.
